(19) United States
(12) Patent Application Publication
(10) Pub. No.: US 2010/0026616 A1
(43) Pub. Date: Feb. 4, 2010

(54) Liquid crystal display

(75) Inventor: Motoshige Okada, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/462,492

(22) Filed: Aug. 4, 2009

(30) Foreign Application Priority Data
Aug. 4, 2008 (JP) P2008-201144

(51) Int. Cl. G09G 3/36

(52) U.S. Cl. 345/96

(57) ABSTRACT

The present invention provides a liquid crystal display including: a plurality of pixels each including one or more liquid crystal elements and one or more first TFT elements; a driving section performing polarity inversion driving by applying driving voltages based on an image signal to the liquid crystal element in each pixel while the driving voltages are inversely polarized; and second TFT elements controlled by the driving section. The first TFT element allows the driving voltage to be applied to the liquid crystal element in its own pixel in accordance with control by the driving section. Each of the second TFT elements allows a couple of liquid crystal elements to be electrically connected to each other. The couple of liquid crystal elements are applied with a couple of driving voltages, respectively, within a same frame period. The couple of driving voltages have inversed polarizations with each other.

### CROSS-REFERENCE TO RELATED APPLICATION

The present application claims priority from Japanese Patent Application No. JP 2008-201144 filed in the Japanese Patent Office on Aug. 4, 2008, the entire content of which is incorporated herein by reference.

### BACKGROUND OF THE INVENTION

1. Field of the Invention

The present invention relates to a liquid crystal display in which image display driving is carried out using a TFT (thin film transistor) element.

2. Description of the Related Art

A large number of liquid crystal displays of active-matrix type has been developed in the past. Recently, the liquid crystal display has a variety of applications and in particular for television, where the pixel count is increasing in accordance with the increase in panel size and higher-definition of digital images, and development of higher frequency operation is in progress to enhance the display performance. As a result, write time per pixel occupied in the displaying time is reduced, and it becomes difficult to secure enough time for writing.

However, just a simple way of increasing the size of the thin film transistor to compensate for the shortage of write time may reduce the aperture ratio, thereby leading to a loss of display luminance. In addition, since the pixel size is becoming smaller due to the above-mentioned higher definition, the effect of lost luminance will be more significant.

Then, an art of precharge operation at the time of writing has been proposed to reduce the write time per pixel (to realize high-speed writing operation) without increasing the size of the TFT as much as possible (with reference to Japanese Patent No. 3632840 for example).

### SUMMARY OF THE INVENTION

However, a potential applied to a data line connected to the pixel to be precharged is equal to the potential provided for other pixel where data writing is currently operated, and is very often different from that of actually intended potential. Accordingly, adjustment in gate voltage and pulse width (application period of the gate voltage) may be necessary in practice in the precharging period. Or it may be necessary to reduce the original write time for the pixel to be displayed so as to squeeze out a precharge period, so that a necessary amount of potential may be written.

As a result, effect of the precharge operation is susceptible to the influences of a potential of the pixel at the time of precharge and a potential of the pixel at the time of writing (influence of potentials before and after the precharge). Accordingly, the effect is not necessarily stable and is dependent on the magnitude of driving voltages in the previous and following frame periods. Further, additional driving system to implement such precharge operation may be also necessary, therefore driving operation may be complicated. What is worse, in the case of reducing the original write time for the pixel to be displayed as mentioned above, potentials of any level may be written but the period of original write time for the pixel to be displayed is reduced by that much. As a result, shortage of writing to the pixel may occur, and it is still difficult to solve the above-mentioned driving and operational problems.

In view of the drawback as described above, it is desirable to provide a liquid crystal display in which bad influence on image quality may be suppressed and high-speed display driving operation may be realized with ease.

A liquid crystal display according to an embodiment of the present invention includes: a plurality of pixels arranged in matrix, each of the pixels including one or more liquid crystal elements and one or more first TFT elements; a driving section performing polarity inversion driving by applying driving voltages based on an image signal to the liquid crystal element in each of the pixels while the driving voltages are inversely polarized; and second TFT elements controlled by the driving section. The first TFT element allows the driving voltage based on the image signal to be applied to the liquid crystal element in its own pixel in accordance with control by the driving section. Each of the second TFT elements allows a couple of liquid crystal elements to be electrically connected to each other, the couple of liquid crystal elements being applied with a couple of driving voltages based on the image signal, respectively, within a same frame period. The couple of driving voltages have inversed polarizations with each other.

In the liquid crystal display according to an embodiment of the present invention, polarity inversion driving is performed by applying driving voltages based on an image signal to the liquid crystal element in each of the pixels in while the driving voltages are inversely polarized, in accordance with control of the first TFT element executed by the driving section. At that time, a couple of liquid crystal elements are electrically connected with each other, in accordance with control of the second TFT elements executed by the driving section. Here, the couple of liquid crystal elements are applied with a couple of driving voltages based on the image signal, respectively, within a same frame period. Then, a low luminance voltage is applied to the liquid crystal elements. Therefore, such low-luminance voltage may be applied before the application of the driving voltage based on an image signal to individual liquid crystal elements. In addition, unlike the precharging operation of related art, application of low-luminance voltage is available without depending on the magnitude of the driving voltages in the previous and following frame periods. What is more, application of such low-luminance voltage rarely complicates the configuration of circuits or driving operation.

According to the liquid crystal display of an embodiment of the present invention, a couple of liquid crystal elements are electrically connected with each other, in accordance with control of the second TFT elements executed by the driving section. Here, the couple of liquid crystal elements are applied with a couple of driving voltages based on the image signal, respectively, within a same frame period. Accordingly, low-luminance voltage may be readily applied to the individual liquid crystal elements before application of the driving voltage based on the image signal without being dependent on the magnitude of the driving voltages in the previous and following frame periods. As a result, high-speed image display driving operation may be realized with ease while suppressing bad influence on image quality.

### BRIEF DESCRIPTION OF THE DRAWINGS

FIG. 1 is a block diagram showing a whole configuration of a liquid crystal display according to an embodiment of the present invention.

FIG. 2 is a pattern diagram to explain the dot inversion driving.

FIG. 3 is a circuit diagram of a detailed configuration example of the pixel according to the embodiment.

FIG. 4 is a circuit diagram to explain the dot inversion driving implemented in the pixel shown in FIG. 3.

FIG. 5 is a timing chart to explain the image display driving according to comparative example 1.

FIG. 6 is a timing chart to explain the image display driving according to comparative example 2.

FIG. 7 is a timing chart to explain the image display driving according to comparative example 3.

FIG. 8 is a timing chart to explain issues of the image display driving according to comparative examples 2 and 3.

FIG. 9 is a timing chart to explain another issue of the image display driving according to comparative examples 2 and 3.

FIG. 10 is a timing chart indicative of an example of the image display driving according to the embodiment.

FIG. 11 is a timing chart indicative of another example of the image display driving according to the embodiment.

FIG. 12 is a timing diagram to explain the black display insertion (black displaying period) according to the embodiment.

FIG. 13 is a timing chart indicative of the image display driving according to modification 1 of the present invention.

FIG. 14 is a timing diagram to explain the black display insertion (black displaying period) according to modification 1.

FIG. 15 is a timing diagram to explain the black display insertion (black displaying period) according to modification 2.

FIG. 16 is a circuit diagram to show a detailed pixel configuration according to modification 3.

FIG. 17 is a circuit diagram to show a detailed pixel configuration according to modification 4.

FIG. 18 is a circuit diagram to show a detailed pixel configuration according to modification 5.

FIG. 19 is a circuit diagram to show a detailed pixel configuration according to modification 6.

FIG. 20 is a circuit diagram to show a detailed pixel configuration according to modification 7.

FIG. 21 is a circuit diagram to show a detailed pixel configuration according to modification 8.

FIG. 22 is a circuit diagram to show a detailed pixel configuration according to modification 9.

FIG. 23 is a pattern diagram to explain the horizontal line inversion driving.

FIG. 24 is a pattern diagram to explain the vertical line inversion driving.

FIG. 25 is a circuit diagram showing an example of pixels when the horizontal line inversion driving is applied.

FIG. 26 is a circuit diagram showing an example of pixels when the vertical line inversion driving is applied.

### DETAILED DESCRIPTION

Embodiments of the invention will be described in detail hereinbelow with reference to the drawings.

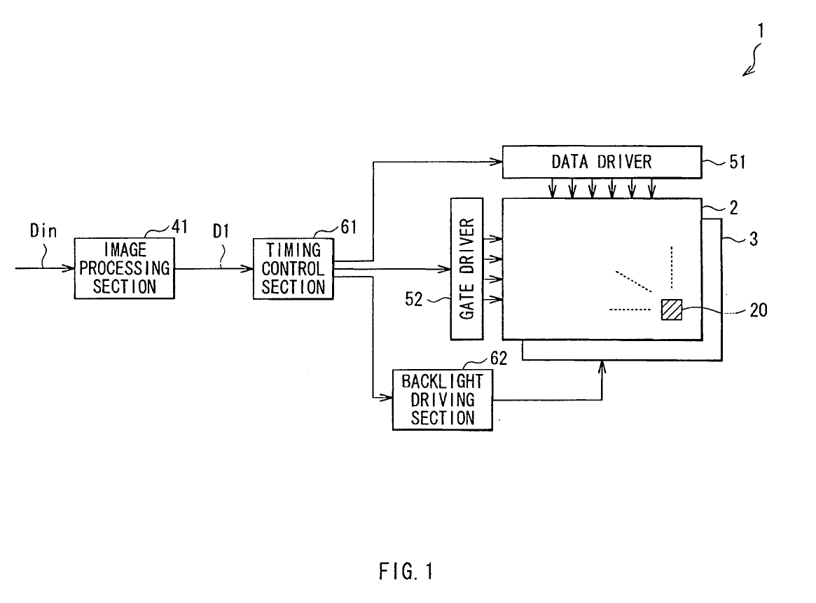

FIG. 1 shows an entire configuration of a liquid crystal display (liquid crystal display 1) according to an embodiment of the present invention. This liquid crystal display 1 includes a liquid crystal display panel 2, a backlight section 3, an image processing section 41, a data driver 51, a gate driver 52, a timing control section 61, and a backlight driving section 62.

The backlight section 3 is a light source emitting an irradiation light to the liquid crystal display panel 2, and is, for example, configured to include CCFL (cold cathode fluorescent lamp), LED (light emitting diode), and so on.

The liquid crystal display panel 2 displays an image according to an image signal Din by modulating the light emitted from the backlight section 3 based on a driving voltage, which is supplied from the data driver 51 according to a driving signal supplied from the gate driver 52 as mentioned hereinbelow. The liquid crystal display panel 2 is configured to include a plurality of pixels 20 that are arranged in matrix as a whole. Each pixel 20 is constituted from pixels corresponding to R(red), G(green) and B(blue), on which color filters of R, G, B not illustrated are attached to emit colored display lights of R, G, and B respectively.

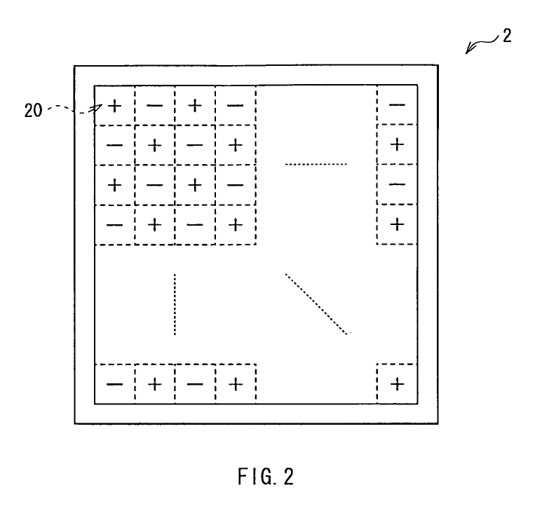

According to the present embodiment, as shown in FIG. 2, for example, what is called a dot inversion driving operation is applied to the respective pixels 20. Namely, driving voltages based on the image signal Din are applied to the liquid crystal elements of individual pixels 20 while inverting the polarization of the driving voltages pixel by pixel.

The image processing section 41 generates an image signal D1 as an RGB signal by applying a specified image processing to the image signal Din transmitted from outside.

The gate driver 52 applies a line sequential drive to each pixel 20 in the liquid crystal display panel 2 along not-illustrated scan lines (gate lines G to be hereinafter described), according to the timing control by the timing control section 61.

The data driver 51 supplies a driving voltage based on the image signal D1 from the timing control section 61 to the individual pixels 20 of the liquid crystal display panel 2. Specifically, the data driver 51 generates an analog image signal (namely, the above-mentioned driving voltage) by applying D/A conversion to the image signal D1, and outputs the analog image signal to the respective pixels 20.

The backlight driving section 62 controls lighting operation (light emitting operation) of the backlight section 3. The timing control section 61 controls the driving timing of the gate driver 52 and the data driver 51, and supplies the image signal D1 to the data driver 51.

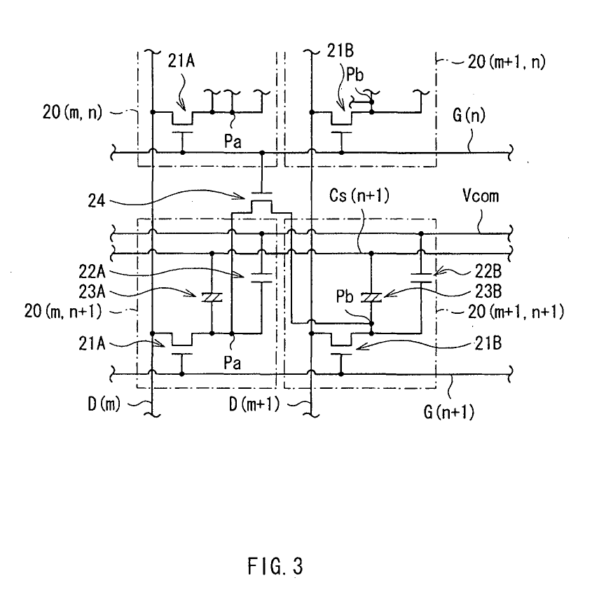

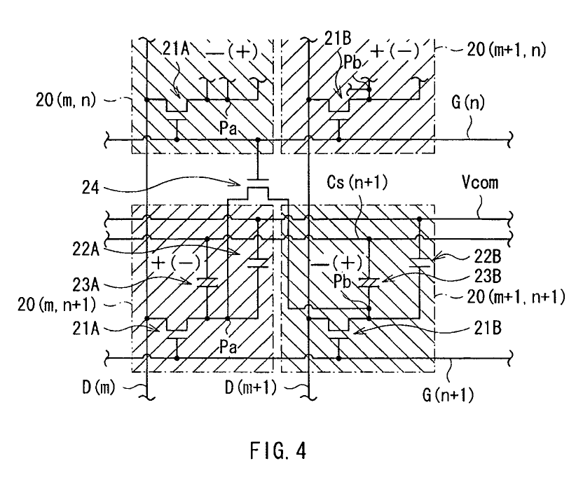

Subsequently, configuration of a pixel circuit formed in each pixel 20 is explained in detail with reference to FIGS. 3 and 4. FIG. 3 shows a configuration example of the pixel circuit in the pixels 20. Reference numerals m and n in the figure are natural numbers respectively, and the pixel 20 (m, n), for example, represents a pixel located in the coordinates (m, n) among the plurality of pixels 20.

The pixel 20(m, n+1) includes a pixel circuit unit configured of a liquid crystal element 22A as a main capacitive element, an auxiliary capacitive element 23A and a TFT element 21A. The pixel 20(m, n+1) is connected to a gate line G(n+1) that selects pixel circuit units to be driven in a line-sequential manner, a data-line D(m) that supplies the driving voltage based on the image signal Din to the pixel circuit unit to be driven, an auxiliary capacitance line Cs(n+1) as a bus line connected to the auxiliary capacitive element 23A, and a common connecting line Vcom.

Similarly, the pixel 20(m+1, n+1) that adjoins the pixel 20(m, n+1) along the gate line G(n+1) includes a pixel circuit unit configured of a liquid crystal element 22B, an auxiliary capacitive element 23B, and a TFT element 21B. The pixel 20(m+1, n+1) is connected to the gate line G(n+1), a data-line D(m+1), the auxiliary capacitance line Cs (n+1) and the common connecting line Vcom.

The liquid crystal elements 22A and 22B function as display element that carries out displaying operation (emission of display light) in accordance with the driving voltage, which is supplied to one end thereof via the TFT elements 21A and 21B from the data-lines D(m) and D(m+1) respectively. These liquid crystal elements 22A and 22B are configured to include a liquid crystal layer, not shown, and a pair of electrodes with the liquid crystal layer in between. One (or one end) of the pair of electrodes is connected to the source of the TFT elements 21A and 21B and one end of the auxiliary capacitive elements 23A and 23B via connection points Pa and Pb, and the other one (the other end) of the pair of electrodes is connected to the common connecting line Vcom. The above mentioned liquid crystal layer is configured of, for example, VA (vertical alignment) liquid crystal or TN (twisted nematic) liquid crystal.

The auxiliary capacitive elements 23A and 23B are capacitive elements capable of stabilizing the stored charge of the liquid crystal elements 22A and 22B, and one ends (electrodes) thereof are connected to the connection point Pa and Pb, and the other ends (common electrodes) are connected to the auxiliary capacitance line Cs(n+1).

The TFT elements 21A and 21B (the first TFT elements) are configured of MOS-FET (metal oxide semiconductor-field effect transistor), where the gate thereof is connected to the gate line G(n+1), the source is connected to the connection points Pa and Pb, and the drain is connected to the data-lines D(m) and D(m+1) respectively. These TFT elements 21A and 21B function as switching elements to supply the driving voltage based on the image signal Din to one ends of the liquid crystal elements 22A and 22B and one ends of the auxiliary capacitive elements 23A and 23B. Specifically, electrical connection between the data-lines D(m), D(m+1), and one ends of the liquid crystal elements 22A, 22B, and one ends of the auxiliary capacitive elements 23A, 23B is selectively established in accordance with a selection signal (gate voltage) supplied from the gate driver 52 via the gate line G(n+1).

A TFT element 24 (the second TFT element) is also configured of a MOS-FET, and its gate is connected to a gate line G (n), and its source and drain are connected to the connection points Pa and Pb respectively. The TFT element 24 establishes an electrical connection between the liquid crystal elements (for example, one ends Pa and PB of the liquid crystal elements 22A and 22B), to which inversely polarized driving voltages based on the image signal Din are respectively applied within a same frame period in accordance with the control operation of the gate driver 52 as shown in FIG. 4, for example. Here, the TFT element 24 electrically connects between the liquid crystal elements 22 in the mutually different pixels 20 (for example, the pixel 20(m, n+1) and the pixel 20(m+1, n+1)). In the present embodiment, a scan line that selectively switches an active state and non-active state of the TFT element 24 (gate line; a second scan line) also serves as a gate line connected to a TFT element 21 of a pixel arranged on a scan line other than that of the pixel 20 which the TFT element 24 belongs to (the gate line G(n) here; a first scan line).

Subsequently, description is made about operation and effects of the liquid crystal display 1 according to the present embodiment.

First, principal operation of the liquid crystal display 1 is explained hereinafter with reference to FIGS. 1 to 4.

In the liquid crystal display 1, as shown in FIG. 1, the image signal Din supplied from outside is image-processed with the image processing section 41, and the image signal D1 for each pixel 20 is generated. The image signal D1 is supplied to the data driver 51 via the timing control section 61. In the data driver 51, D/A conversion is applied to the image signal D1 and an analog image signal is generated. Then the dot inversion driving operation is applied in a line sequential manner to individual pixels 20 with the driving voltage outputted from the gate driver 52 and the data driver 51.

Specifically, the active state and the non-active state (ON/OFF) of the TFT elements 21A and 21B are switched in accordance with the selection signal supplied from the gate driver 52 via the gate line G, and electrical connection between the data-line D and the liquid crystal elements 22A, 22B and the capacitive elements 23A, 23B is selectively established, as shown in FIGS. 2 and 3. Thus the driving voltage based on the image signal supplied from the data driver 51 is supplied to the liquid crystal elements 22A and 22B in this manner and image display driving operation is executed.

Then, in the pixel 20 where the electrical connection between the data-line D and the liquid crystal elements 22A, 22B and the capacitive elements 23A, 23B is established, illumination light from the backlight section 3 is modulated in the liquid crystal display panel 2 and outputted as a display light. Image display based on the image signal Din is thus performed in the liquid crystal display 1.

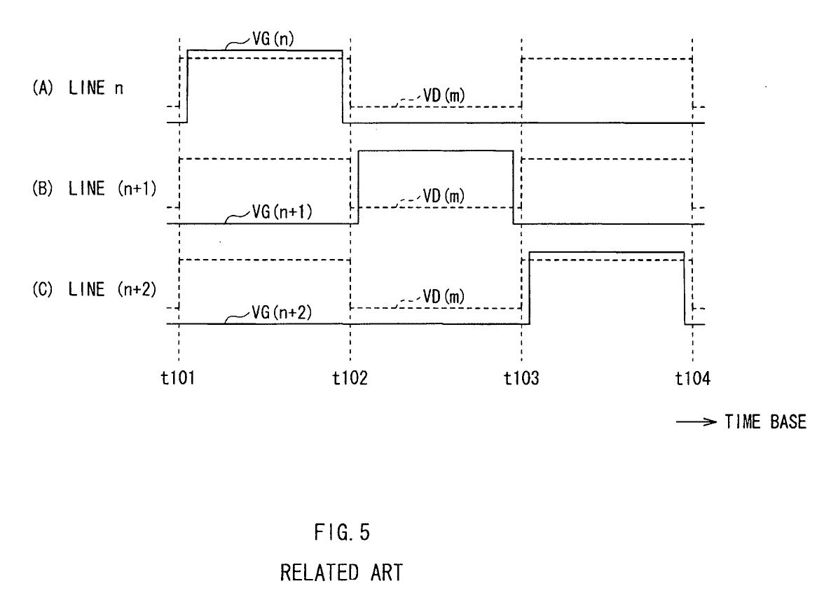

Subsequently, characteristic operation and effects of the liquid crystal display according to an embodiment of the present invention is described in detail hereinafter with reference to FIGS. 5 to 12 as compared with comparative examples. Here, FIGS. 5 to 7 are timing charts indicative of image display driving executed by a liquid crystal display of related art, which correspond to the comparative examples 1 to 3 respectively. Here, (A) to (C) represent line (n), line (n+1), and line (n+2) respectively.

Comparative example 1 of FIG. 5 (timing of t101 through t104) represents a simple image display driving operation of related art. In this case, because of the increase in pixel count due to the increase in panel size and higher-definition of digital image, and because of higher frequency operation to improve display performance, write time per pixel occupied in the displaying time is reduced, and it is difficult to secure sufficient time for writing.

However, just a simple way of increasing the size of the TFT element to compensate for the shortage of write time may reduce the aperture ratio, thereby leading to a loss of display luminance. In addition, since the pixel size is becoming smaller due to the above-mentioned higher definition, the effect of lost luminance will be more significant.

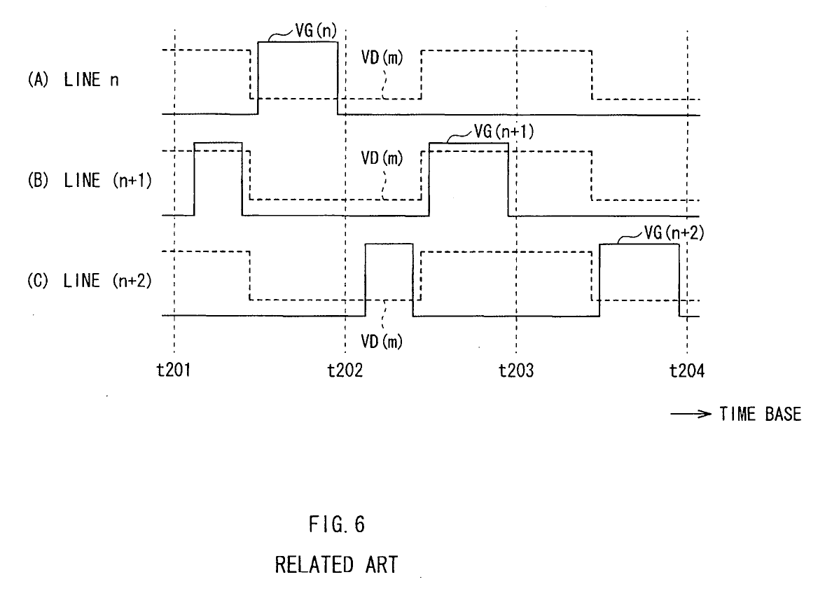

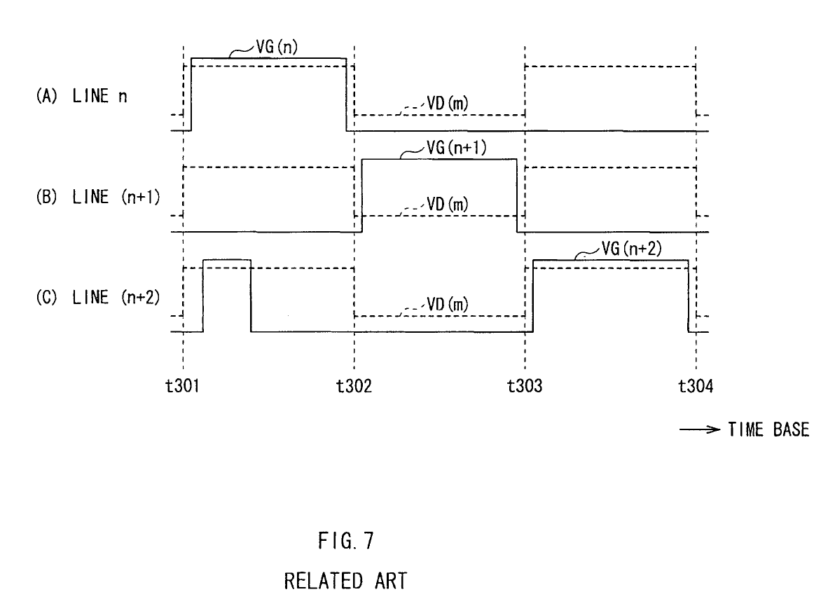

So, in comparative examples 2 and 3 (the timing of t201 through t204 and t301 through t304) of FIGS. 6 and 7, a precharge operation at the time of writing is employed in order to reduce the write time per pixel (to realize high-speed writing operation) without increasing the size of the TFT element as much as possible.

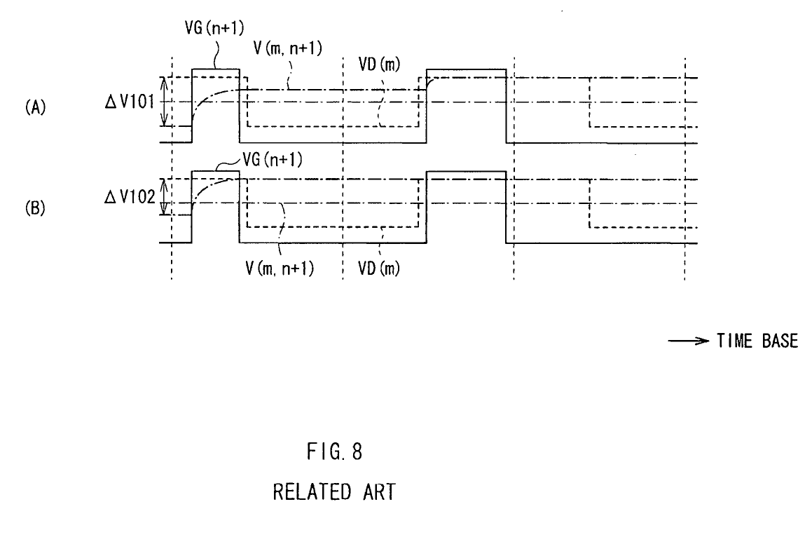

However, these comparative examples 2 and 3 have such problems as follows (here, description is made hereinbelow about comparative example 2). First, effect of the precharge operation is susceptible to the influences of a potential of the pixel at the time of precharge and a potential of the pixel at the time of writing (influence of potentials before and after the precharge). As a result, as indicated by the electric potential differences ΔV101 and ΔV102 shown in (A) and (B) of FIG. 8 for example, necessary amount of precharging may differ depending on the pixel potentials held by the previous frame display.

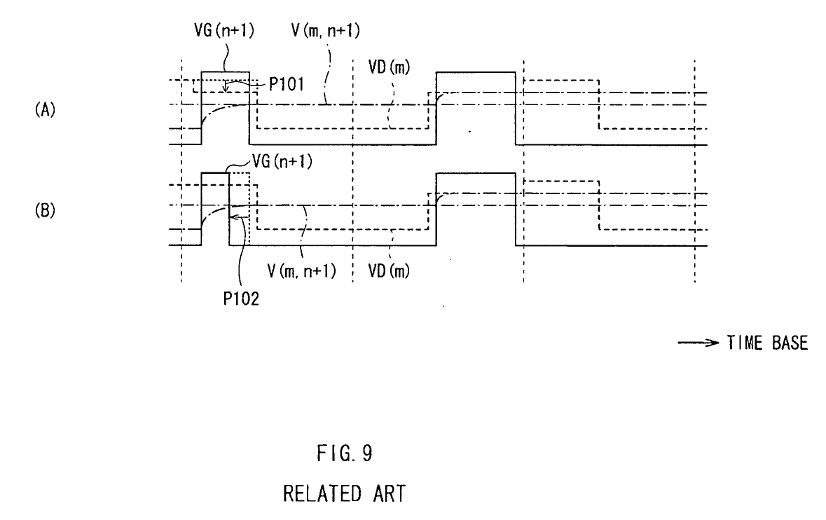

Accordingly, if the potential at the time of precharge is equal to or more than the writing potential, adjustment in gate voltage (with reference to arrow P101) and pulse width (application period of the gate voltage) (with reference to arrow P102) may be required in practice in the precharging period as shown in (A) and (B) of FIG. 9, for example.

Accordingly, as in the image display driving of comparative examples 2 and 3 (namely, the image display driving using the precharge operation), the effect thereof is not necessarily stable and is dependent on the magnitude of driving voltages in the previous and following frame periods. In addition, additional driving system to implement such precharge operation may be also necessary so that driving operation may be complicated.

Meanwhile, according to the present embodiment, inversely polarized driving voltages based on the image signal Din are applied to the liquid crystal elements 22A and 22B of respective pixels 20 in accordance with the operational control of the TFT elements 21A and 21B executed by the data driver 52 and the gate driver 51, thus dot inversion driving is carried out as shown in FIGS. 1 to 4. At that time, the liquid crystal elements 22A and 22B, to which inversely polarized driving voltages based on the image signal Din are respectively applied in a same frame period, are electrically connected to each other in accordance with the operational control of the second TFT element executed by the gate driver 51.

With such configuration, image display driving is operated in such a manner as described hereinbelow according to the present embodiment. Here, it is to be noted that when the individual pixels mutually connected via the TFT element 24 are defined as pixel A and pixel B (for example, pixel 20(m, n+1) and pixel 20(m+1, n+1)), pixel potentials of the pixel A and pixel B, which are relative potential with respect to the reference potential, be defined as V_{PA} and V_{PB} respectively, the pixel potential across the pixel A and pixel B at the operation of the TFT element 24 be defined as V_{AB}, and total quantity of electric charge of the pixel A and pixel B be defined as Q_{AB}.

Here, the quantity of electric charge Q_{A} of the pixel A is expressed as Q_{A}=α(V_{PA}) where α is the capacitance coefficient and V_{PA} is the potential of the pixel A. Similarly, the quantity of electric charge Q_{B} of the pixel B is expressed as Q_{B}=β(V_{PB}) where β is the capacitance coefficient and V_{PB} is the potential of the pixel B. Here, since Q_{A} and Q_{B} are inversely polarized charges each other, Q_{AB} satisfies such expression as

|Q_{AB}|≈||Q_{A}|−|Q_{B||}

At this time, the total quantity of electric charge Q_{AB} of the mutually-connected pixels A and B is expressed by Q_{AB}=γV_{AB} with use of the coefficient γ. Accordingly, the pixel potential V_{AB} across the pixel A and the pixel B at the operation of the TFT element 24 becomes a fixed value. Namely, the liquid crystal elements 22A and 22B, to which inversely polarized driving voltages based on the image signal Din are respectively applied in a same frame period, are electrically connected in accordance with the operational control of the TFT element 24 executed by the gate driver 51, thus a low luminance voltage of a fixed magnitude is applied to the liquid crystal elements 22A and 22B.

When the threshold voltage of liquid crystal material that configures the liquid crystal elements 22A and 22B is defined as V_{thLC}, it is desirable to satisfy the following expression (1):

V_{thLC}≧|V_{AB}| (1)

Namely, it is desirable that the potential across the liquid crystal elements 22A and 22B at the time that they are electrically connected via the TFT element 24 be equal to or less than the threshold voltage of the liquid crystal material configuring the liquid crystal elements 22A and 22B.

That is because the liquid crystal elements 22A and 22B exhibit a constantly stable displaying condition when their potential is equal to or less than the liquid crystal threshold voltage V_{thLC}. Here, if liquid crystal material having a characteristic of constantly displaying black in the potential equal to or less than the threshold voltage V_{thLC} is employed, the pixel 20 may typically display black at the operation of the TFT element 24. In this manner, bad influence on the display which was found in the past at the time of black display may be reduced as described later.

When the above-mentioned expression (1) is satisfied, since the pixel potential before writing satisfies a requirement that it is typically within the range from the reference potential of the pixel 20 to the threshold voltage V_{thLC} of the liquid crystal material, bad effects on image quality may be suppressed while reducing the load on the pixel 20 at the time of writing.

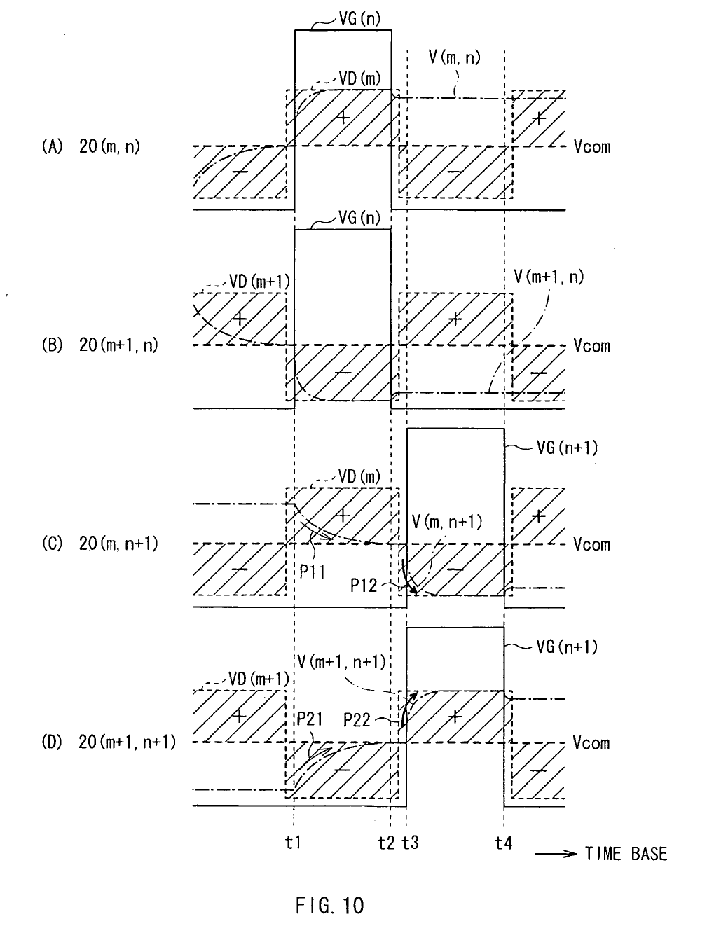

Subsequently, detailed example of an image display driving waveform (timing of t1 through t4) according to the present embodiment will be explained with reference to FIG. 10. FIG. 10 is a timing diagram expressing the image display driving according to the present embodiment. Here, (A) to (D) represent the driving waveform of the pixels 20(m, n), 20(m+1, n), 20(m, n+1), and 20(m+1, n+1) respectively. VG(n) etc., represent voltage waveforms (gate voltage waveform) of gate lines G(n) and so on; VD(m) etc., represent voltage waveforms (data voltage waveform) of data-lines D(m) and so on; and Vcom represents the voltage of common electrode (common voltage). The above-defined symbols are applied in the descriptions hereinbelow.

First, as shown by the arrows P11 and P21 in the pixels 20(m, n+1) and 20(m+1, n+1) of FIG. 10, the TFT element 24 comes into an active state in accordance with the gate voltage VG(n) of the gate line G(n), and the liquid crystal elements 22A and 22B to which inversely polarized driving voltages are respectively applied are electrically connected. A fixed magnitude of low-luminance voltage is thereby applied across the liquid crystal elements 22A and 22B (low-luminance voltage period or black displaying period).

Subsequently, as shown by the arrows P12 and P22 in the pixels 20(m, n+1) and 20(m+1, n+1) of the figures, the TFT elements 21A and 21B come into an active state in accordance with the gate voltage VG(n+1) of the gate line G(n+1). Then, the driving voltage based on the image signal Din (voltages VD(m) and VD(m+1) of data-lines D(m) and D(m+1)) is thereby written to the liquid crystal elements 21A and 21B, and the pixel potentials V(m, n+1) and V(m+1, n+1) are generated.

Namely, in the pixels 20(m, n+1) and 20(m+1, n+1) the TFT element 24 which is electrically connected to the liquid crystal elements 22A and 22B of those pixels starts its operation before the driving voltage based on the image signal Din starts to be supplied to TFT elements 21A and 21B.

Thus low-luminance voltage (black display voltage) may be applied to the individual liquid crystal elements 22A and 22B previous to the application of the driving voltage based on the image signal Din. Such application of low-luminance voltage is available without depending on the magnitude of driving voltages in the previous and following frame periods unlike the precharge operation of related art. What is more, such application of low-luminance voltage rarely complicates the configuration of circuit or driving operation.

In the present embodiment, black display is typically available as far as the pixel potential at the operation of the TFT element 24 is equal to or less than the threshold voltage V_{thLC} of liquid crystal when the above-mentioned expression (1) is satisfied. Accordingly, black display insertion in each frame period is implemented based on such principle.

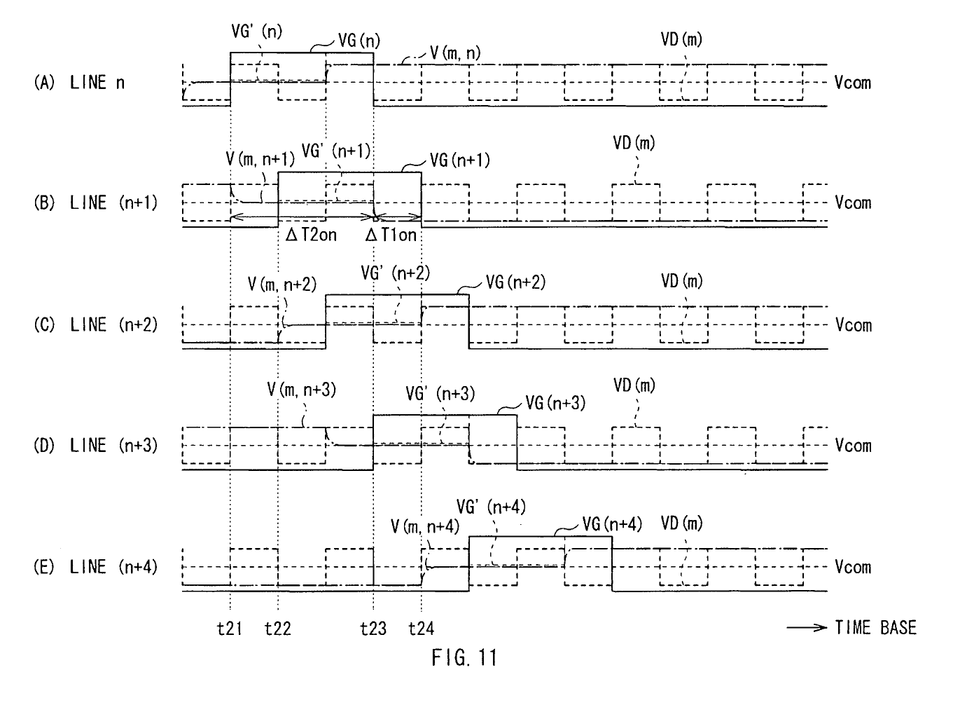

Subsequently, detailed description is made about a black display insertion (black displaying period) according to the present embodiment. FIG. 11 is a timing chart indicative of the image display driving according to the present embodiment is indicated by means of timing waveforms (the timing of t21 through t24) of line (n) to line (n+4).

First, the pixel potential V(m, n+1) connected to the gate line G(n+1) comes to a black potential (potential equal to or less than the threshold value of the liquid crystal) when the TFT element 24 is in active state with the gate line voltage VG(n). When the TFT element 24 is in non-active state with the gate voltage VG(n) and the TFT element 21A is in an active state with the gate voltage VG(n+1), the pixel potential V(m, n+1) gets to an intended write potential (normal display period: ΔT1on) by application of the data-line voltage VD(m) based on the image signal Din.

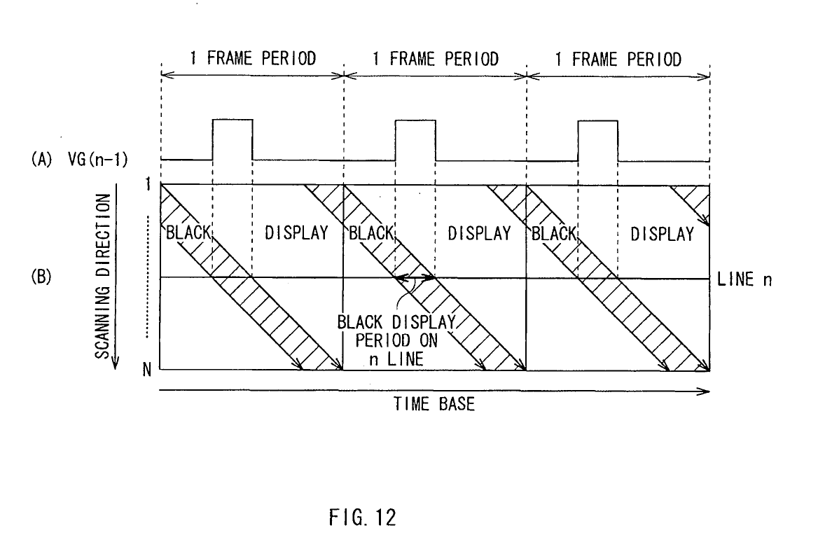

In this case, since the liquid crystal elements 22A and 22B to which inversely polarized driving voltages are respectively applied are electrically connected to apply a fixed low-luminance voltage to these liquid crystal elements 22A and 22B, and since the above-mentioned expression (1) is satisfied, the pixel 20 (m, n+1) comes to a black display state (black displaying period: ΔT2on). Thus the black display insertion in each frame period is implemented as shown in FIG. 12, for example.

In FIG. 10, although the value of the gate voltage VG is constant from its rise to fall, it is not limited to this. Namely, the gate voltage applied to the TFT element 24 may be varied within the active period of the TFT element 24 as shown by, for example, the gate voltages VG′(n) to VG′(n+4) of FIG. 11.

As mentioned above, according to the present embodiment, the liquid crystal elements 22A and 22B, to which inversely polarized driving voltages based on the image signal Din are respectively applied in a same frame period, are electrically connected in accordance with the operational control of the TFT element 24 executed by the gate driver 52. As a result, low-luminance voltage is easily applied to each of the liquid crystal elements 22A and 22B before application of the driving voltage based on the image signal Din without being dependent on the magnitude of the driving voltages in the previous and following frame periods. As a result, high-speed image display driving operation may be realized with ease while suppressing bad influence on image quality.

Since the capacitance of liquid crystal may be changed without depending on the potential of data lines D unlike the precharging operation of related art, bad influence on image quality may be suppressed and substantial variation of potential is available before writing to a subsequent frame. That may reduce the quantity of electric charge required at the time of writing, thereby expanding the drive margin for writing at the time of high speed driving such as a double-speed drive. In addition, since writing performance may be stabilized under any condition, there may be no problem of pattern-dependent flicker as shown in the precharging, and of dependency on display screens such as instability of display quality depending on the type of display screen.

In addition, since the TFT element 24, which are electrically connected to the liquid crystal elements 22A and 22B in pixels, starts its operation before the driving voltage based on the image signal Din is supplied to the TFT elements 21A and 21B, effects on the display quality may be reduced to the minimum.

What is more, application of the voltage to the gate line of the TFT element 24 makes it possible to suppress motion blur of dynamic images displayed on the screen and keep the good enough display luminance thereof without decreasing the write time to the pixel 20 executed by the TFT elements 21A and 21B. Further, the black display insertion time in each frame period may be varied without reducing the time to write to the pixel 20.

Subsequently, modifications of an embodiment of the present invention are taken up and explained. It is to be noted that, in the modifications, the same reference numerals are designated to the same elements as those shown in the present embodiment and their description is appropriately omitted.

### (Modification 1)

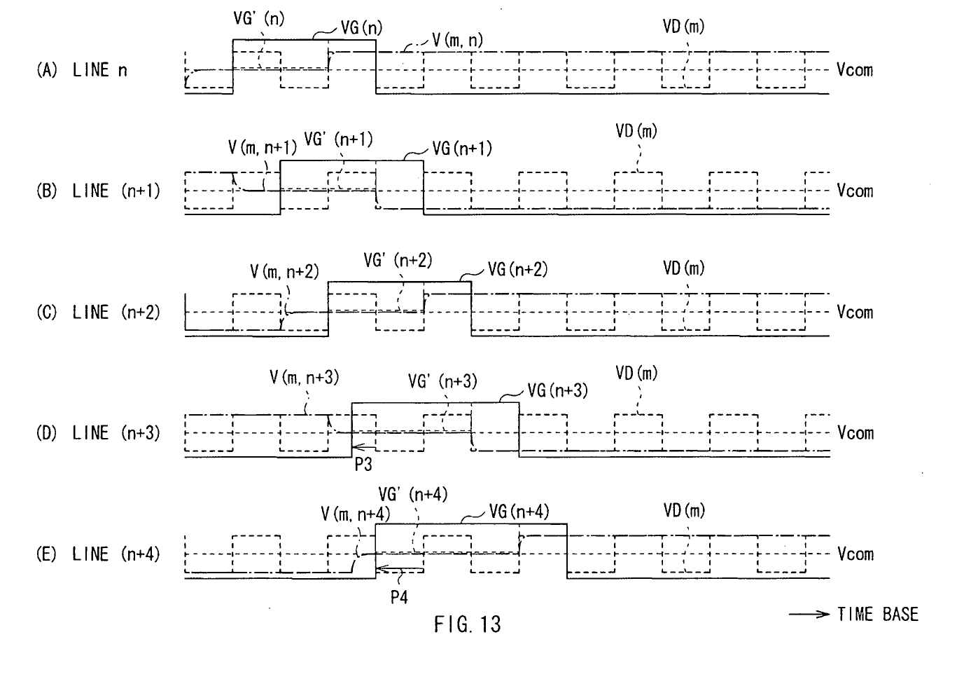

FIG. 13 is a timing chart indicative of the image display driving of modification 1, which corresponds to FIG. 11 of the above-mentioned embodiment.

in the Present Modification, Active Period of the TFT element 24 is varied by each scan line (by each horizontal pixel line), as shown by the arrows P3 and P4 in the figure, so that the low-luminance voltage period (black displaying period), which is a period where the potential of the liquid crystal elements 21A and 21B is equal to or less than the threshold voltage V_{thLC} of liquid crystal, is varied by each scan line within the same frame period. Namely, under the condition that the gate voltage VG (n+1) becomes OFF-state earlier than the gate voltage VG(n) at least within the same frame, the rise of the gate voltage waveform may be shifted arbitrarily with the fall thereof fixed.

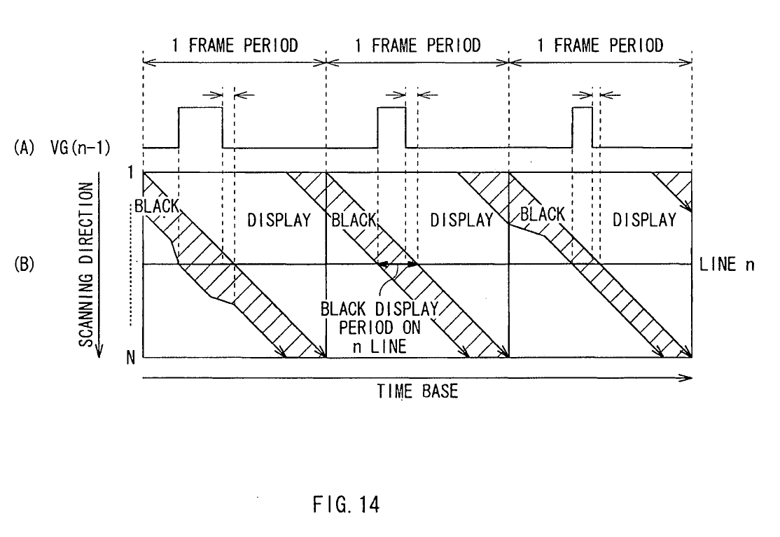

In this manner, black display portions having different black display periods in each frame period may be depicted without changing the write time per pixel, by controlling the fall timing of the gate voltage VG(n+1) to be just one frame period after the fall timing of the gate voltage VG(n), as shown in FIG. 14, for example.

Since the black display insertion period is variable depending on the luminance of the display screen, even a display screen with high contrast ratio may suppress its motion blur in the dynamic image displayed on the screen by applying the black display insertion only in the necessary scan lines, and keep a good luminance by suppressing fall of the luminance of a portion where the black display insertion is not necessary.

According to the present modification, too, the gate voltage applied to the TFT element 24 may be varied within the active period of the TFT element 24 as with the case of the gate voltages VG′(n) to VG′(n+4) of FIG. 13, for example.

### (Modification 2)

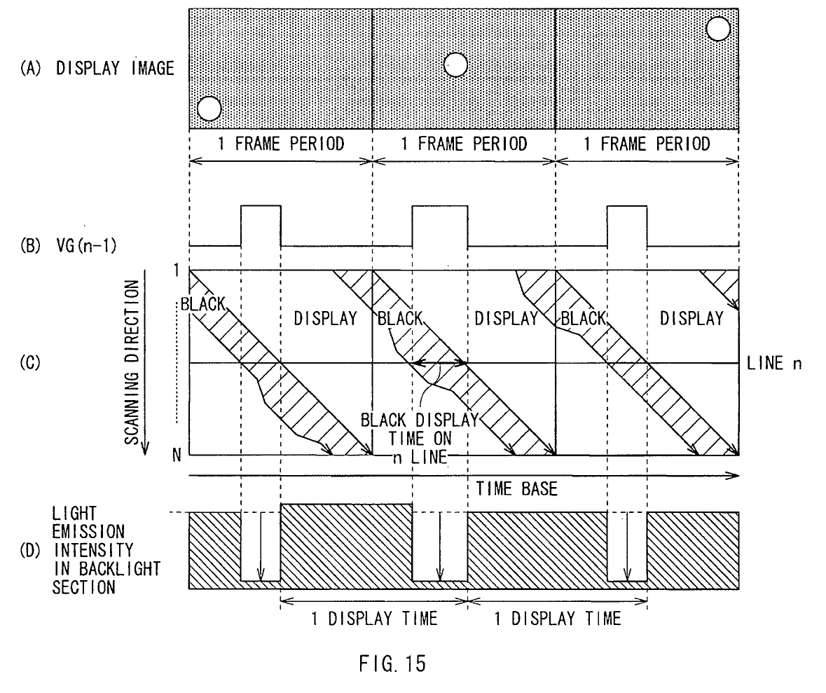

FIG. 15 is a timing diagram indicative of the image display driving according to modification 2, which corresponds to the above-mentioned embodiment of FIG. 12 and the modification 1 of FIG. 14.

In the present modification, the backlight section 3 is divided into a plurality of partial light emitting blocks each extending in a horizontal direction. Then, the luminance of the irradiation light emitted from a partial light emitting block of the plurality of partial light emitting blocks, in a position corresponding to a horizontal pixel line in which black display is performed, falls in synchronization with the low-luminance voltage period (black displaying period) based on the drive controlling by the backlight driving section 62. In addition, the integrated quantity of the irradiation light from the backlight section 3 is controlled to be equal by each display period excluding the black display insertion time or by each displaying time.

In this manner, effects of low power consumption and improvement of image quality by means of black display insertion may be further enhanced by falling the luminance of the backlight section 3 of a portion corresponding to the black display portion in accordance with the portion of the black display insertion.

### (Modifications 3 and 4)

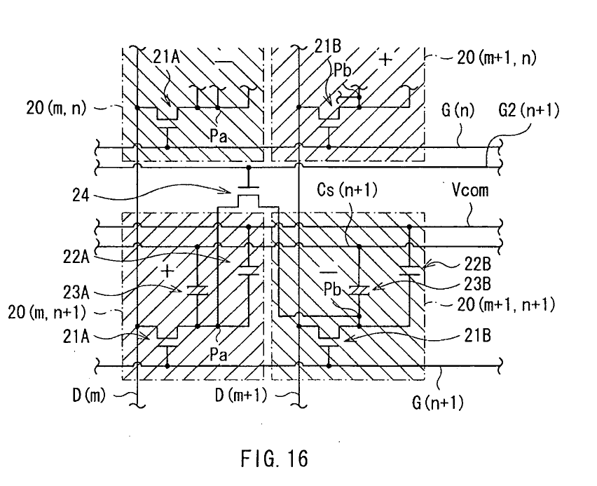

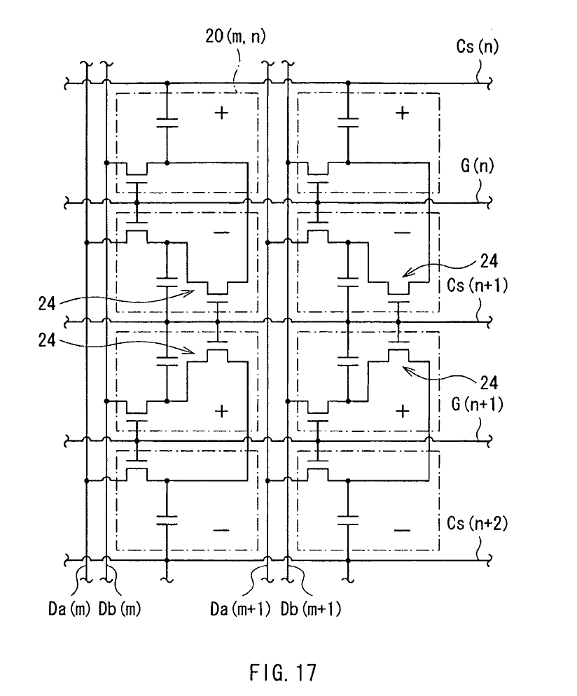

FIGS. 16 and 17 illustrate the pixel circuits of the pixel 20 according to modifications 3 and 4.

In modification 3 of FIG. 16, a scan line that selectively switches between active state and non-active state of the TFT element 24 (for example, the gate line G2(n+1)) is prepared separately from the gate line connected to the TFT elements 21A and 22A (for example, gate line G(n+1)).

Meanwhile, in modification 4 of FIG. 17, a scan line that selectively switches between the active state and the non-active state of the TFT element 24 also serves as an auxiliary capacitance line (for example, the auxiliary capacitance line Cs(n+1)).

As described above, the scan line that selectively switches between the active state and the non-active state of the TFT element 24 does not necessarily need to serve as the gate line connected to the TFT elements 21A and 22A (for example, the gate line G(n+1)) as with the above mentioned embodiments.

### (Modifications 5-8)

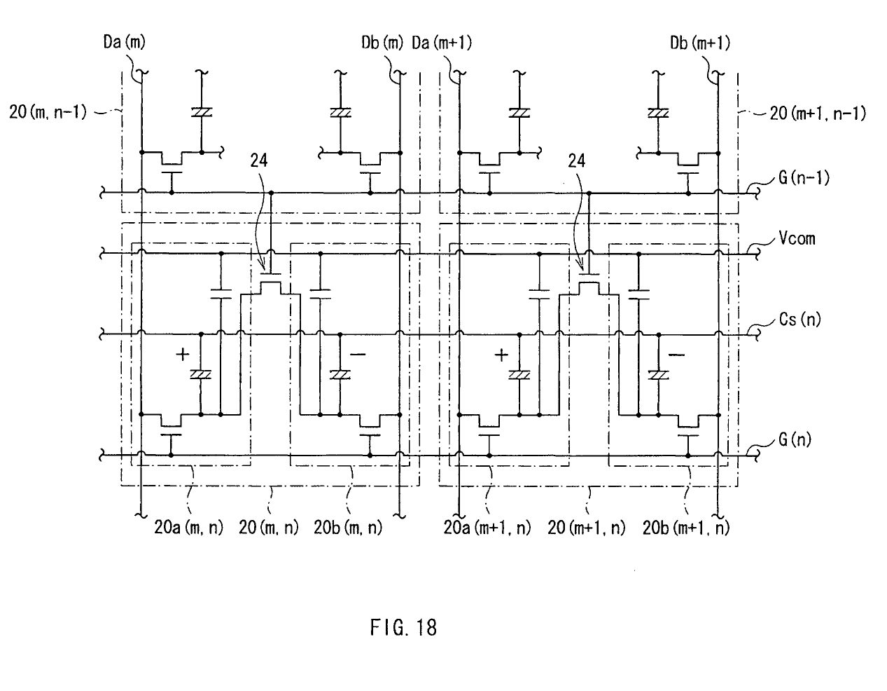

FIGS. 18 to 21 illustrate the pixel circuits of the pixel 20 according to modifications 5 to 8. In the modifications 5 to 8, each pixel 20 is configured of a plurality of sub pixels (here two sub pixels) respectively including the liquid crystal element 22 and the TFT element 21 to further improve the display performance of liquid crystal display.

Specifically, in the modification 5 of FIG. 18, the TFT element 24 electrically connects the liquid crystal elements 22 in mutually different sub pixels 20a and 20b of the same pixel 20.

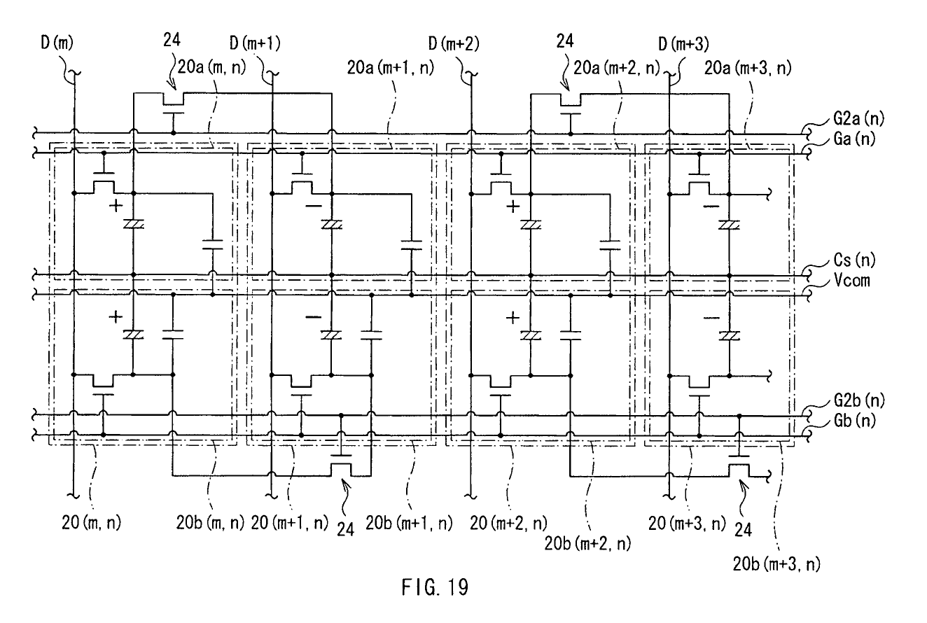

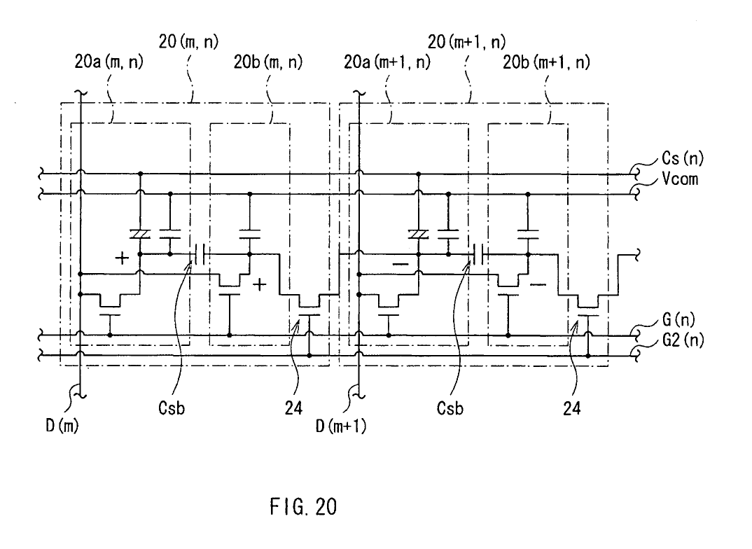

In the modifications 6 and 7 of FIGS. 19 and 20, the TFT element 24 electrically connects the liquid crystal elements 22 in the sub pixels 20a and 20b of mutually different pixels 20.

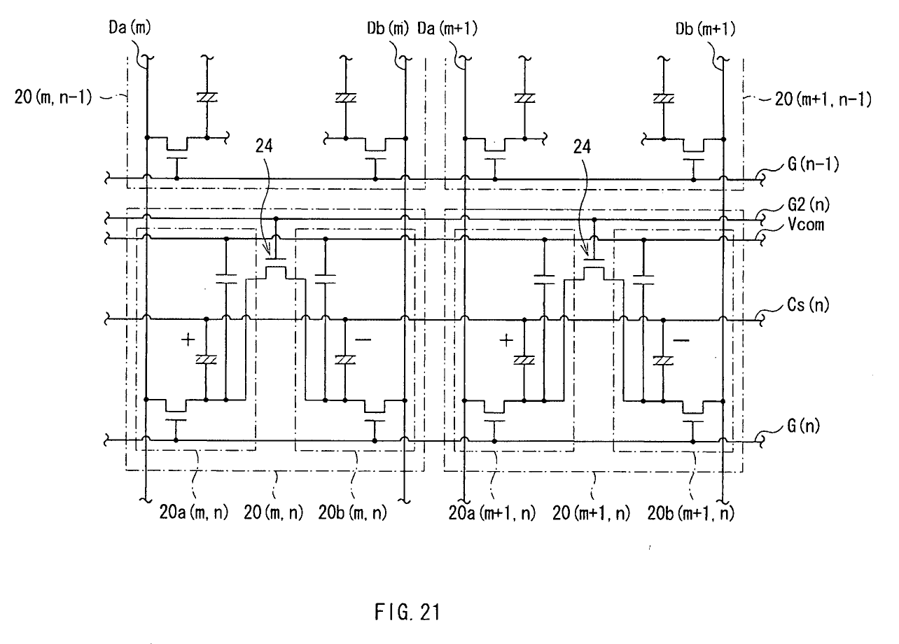

Similarly, in the modification 8 of FIG. 21, the TFT element 24 electrically connects the liquid crystal elements 22 in mutually different sub pixels 20a and 20b of the same pixel 20. However, in modification 8, a scan line that selectively switches between the active state and non-active state of the TFT element 24 (For example, the gate line G2(n)) is prepared separately from a gate line connected to the TFT element 21 (for example, the gate line G(n−1)) unlike the above-mentioned modifications 5 to 7.

With such configuration, the sub pixels that are respectively written in reverse polarities make it possible to obtain the pixel potential within a very close range from the common electric potential Vcom without difficulty after the operation of the TFT element 24. As a result, writing performance may be stabilized under any condition, and there may be no problem of pattern-dependent flicker as shown in the precharging, and of dependency on display screens such as instability of display quality depending on the type of display screen.

### (Modification 9)

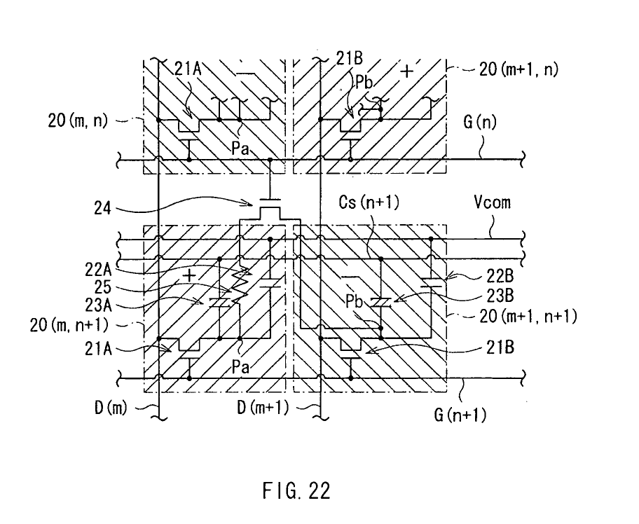

FIG. 22 illustrates the pixel circuit of the pixel 20 according to modification 9.

According to the present modification, a resistance element is disposed as a protective element 25 (protection circuit) between the liquid crystal elements 21A and 21B electrically connected via the TFT element 24.

In this manner, the data driver 51 and the gate driver 52 may be electrically protected.

The protection circuit is not limited to the resistance element and may be configured of any other protective elements.

As described above, although the present invention has been described with reference to the embodiment and modifications, the invention is not limited to such embodiment and modifications but may be variously modified.

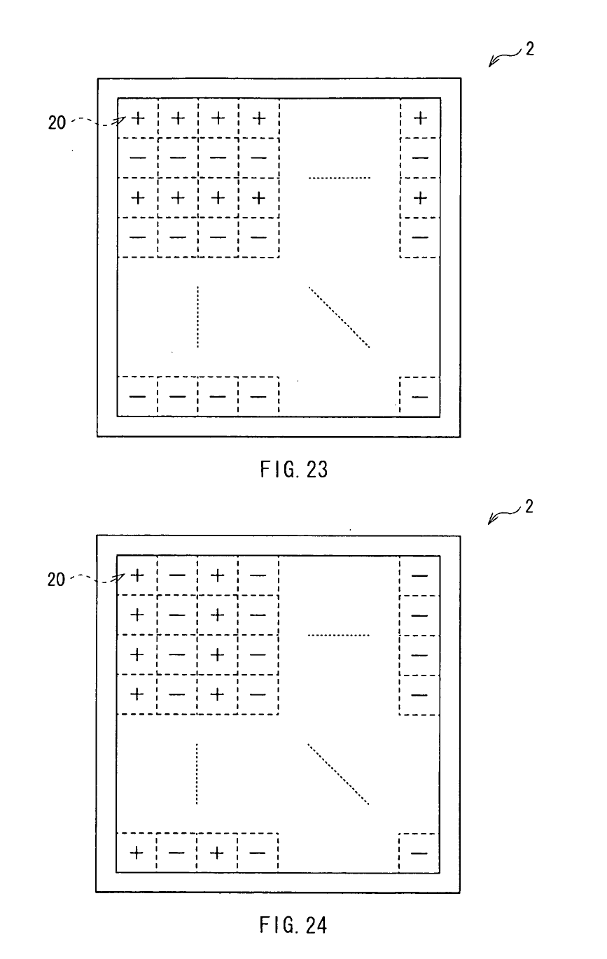

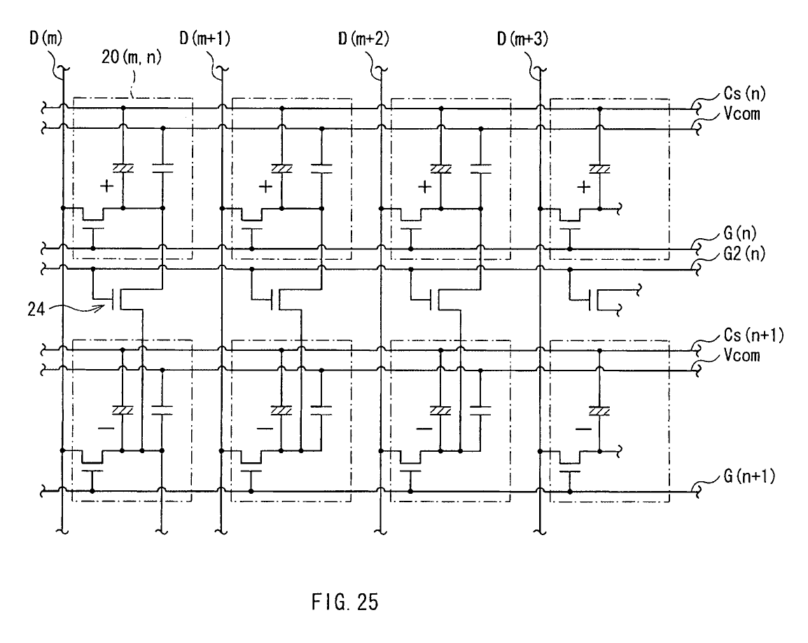

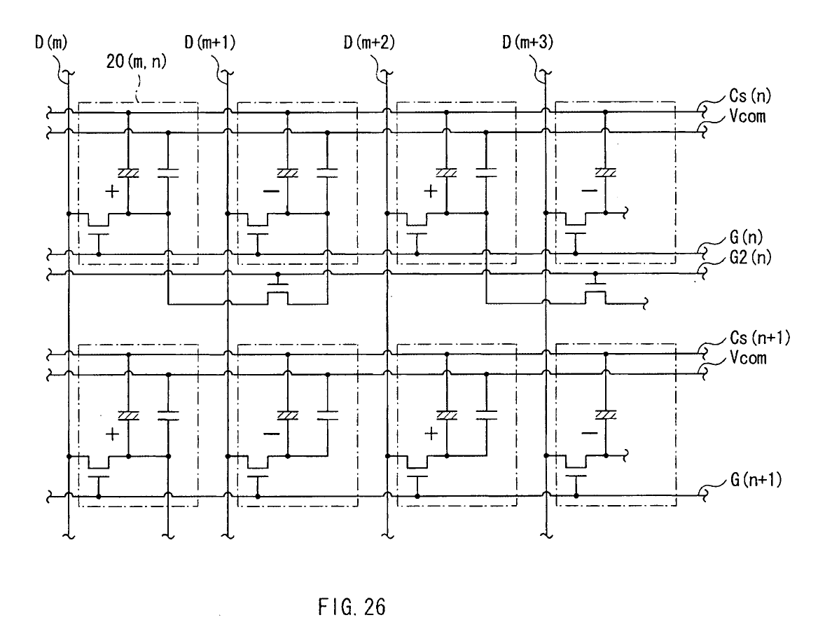

For example, although the dot inversion driving operation is explained in the above-mentioned embodiments and the like, it may be a horizontal line inversion driving operation as shown in FIG. 23 or vertical line inversion driving operation as shown in FIG. 24, for example. Specifically, a pixel circuit is configured typically as shown in FIG. 25 in the case of the line inversion driving. The pixel circuit is configured typically as shown in FIG. 26 in the case of the column line inversion driving.

In the above mentioned embodiments, although pixels including the mutually connected liquid crystal elements adjoin each other in the right and left direction, they do not necessarily adjoin, and may be located in the right and left, above and below or oblique direction.

In addition, the liquid crystal elements connected via the TFT element 24 are not necessarily connected physically and directly and may be connected electrically.

It should be understood by those skilled in the art that various modifications, combinations, sub-combinations and alterations may occur depending on design requirements and other factors insofar as they are within the scope of the appended claims or the equivalents thereof.

1. A liquid crystal display comprising:
a plurality of pixels arranged in matrix, each of the pixels including one or more liquid crystal elements and one or more first TFT elements;
a driving section performing polarity inversion driving by applying driving voltages based on an image signal to the liquid crystal element in each of the pixels while the driving voltages are inversely polarized; and
second TFT elements controlled by the driving section;
the first TFT element allowing the driving voltage based on the image signal to be applied to the liquid crystal element in its own pixel in accordance with control by the driving section; and
each of the second TFT elements allowing a couple of liquid crystal elements to be electrically connected to each other, the couple of liquid crystal elements being applied with a couple of driving voltages based on the image signal, respectively, within a same frame period, the couple of driving voltages having inversed polarizations with each other.

2. The liquid crystal display according to claim 1, wherein
when the couple of liquid crystal elements are electrically connected with each other through the second TFT element, a potential in the couple of liquid crystal elements is equal to or less than a liquid crystal threshold voltage.

3. The liquid crystal display according to claim 2, wherein a TFT element line composed of a series of the second TFT elements located along a horizontal direction is provided in correspondence with a horizontal pixel line composed of a series of pixels located along a horizontal direction, and
the driving section controls to change length of an active period of the second TFT elements, separately for individual TFT element line, thereby length of a low-luminance voltage period where the potential across the liquid crystal elements is equal to or less than the threshold voltage is controlled to be changed, separately for individual horizontal pixel line, within a frame period.

4. The liquid crystal display according to claim 3, further comprising a light source that emits light to the liquid crystal elements in the pixels, wherein the luminance of the light from the light source falls in synchronization with the low-luminance period.

5. The liquid crystal display according to claim 2, wherein the driving section controls to change the gate voltage applied to the second TFT element in the active period of the second TFT element.

6. The liquid crystal display according to claim 1, wherein
a first gate line selectively switching between active state and non-active state of the first TFT element is connected to the first TFT element; and
a second gate line selectively switching between the active state and non-active state of the second TFT element also serves as a first gate line connected to the first TFT elements in the pixels in a horizontal pixel line, the horizontal pixel line being different from a horizontal pixel line corresponding to a TFT element line which the second TFT element belongs to.

7. The liquid crystal display according to claim 6, wherein the driving section controls the first and the second TFT elements so that the second TFT element electrically connected to a liquid crystal element of a pixel starts its operation before the driving voltage based on the image signal starts to be applied to the first TFT element of the pixel.

8. The liquid crystal display according to claim 1, wherein
a first gate line selectively switching between the active state and non-active state of the first TFT element is connected to the first TFT element; and
a second gate line selectively switching between the active state and non-active state of the second TFT element is provided separately from first gate line.

9. The liquid crystal display according to claim 1, wherein
each of the plurality of pixels further includes an auxiliary capacitive element; and
a second gate line selectively switching between active state and non-active state of the second TFT element also serves as an auxiliary capacitive line connected to the auxiliary capacitive element in a pixel on a horizontal pixel line corresponding to a TFT element line to which the second TFT element belongs.

10. The liquid crystal display according to claim 8, wherein the driving section controls the first and the second TFT elements so that the second TFT element electrically connected to a liquid crystal element of a pixel starts its operation before the driving voltage based on the image signal starts to be applied to the first TFT element of the pixel.

11. The liquid crystal display according to claim 9, wherein the driving section controls the first and the second TFT elements so that the second TFT element electrically connected to a liquid crystal element of a pixel starts its operation before the driving voltage based on the image signal starts to be applied to the first TFT element of the pixel.

12. The liquid crystal display according to claim 1, wherein the second TFT element allows a liquid crystal element in a pixel to be electrically connected to a liquid crystal element in another pixel.

13. The liquid crystal display according to claim 1, wherein
each of the pixels is configured of a plurality of sub pixels, each of the sub pixels including a liquid crystal element and a first TFT element; and
the second TFT element allows a liquid crystal element in a sub pixel in a pixel to be electrically connected to a liquid crystal element in another sub pixel in the same pixel.

14. The liquid crystal display according to claim 1, wherein
a pixel is configured of a plurality of sub pixels, each of the plurality of sub pixels including the liquid crystal element and the first TFT element; and
the second TFT element allows a liquid crystal element in a sub pixel in a pixel to be electrically connected to a liquid crystal element in a sub pixel in another pixel.

15. The liquid crystal display according to claim 1, wherein a protection circuit allowing the driving section to be electrically protected is provided between a couple of liquid crystal elements electrically connected to each other via the second TFT element.
